(19) United States
(12) Patent Application Publication
(10) Pub. No.: US 2025/0386766 A1
(43) Pub. Date: Dec. 25, 2025

(54) SYSTEM AND METHOD FOR AN AGRICULTURAL HARVESTER

(71) Applicant: CNH Industrial Canada, Ltd, Saskatoon (CA)

(72) Inventor: Martin Roberge, Quebec (CA)

(21) Appl. No.: 19/244,045

(22) Filed: Jun. 20, 2025

(30) Foreign Application Priority Data
Jun. 21, 2024 (BR) 10 2024 012720 0

(51) Int. Cl. A01D 45/10

(52) U.S. Cl. CPC A01D 45/10

(57) ABSTRACT

A debris removal system for an agricultural harvester can include an extractor housing defining a housing inlet and a housing outlet. The extractor housing can further define an airflow channel for directing the debris through the extractor from the housing inlet to the housing outlet. An airflow device can be configured to generate an airflow from the housing inlet towards the airflow device. The airflow can be configured to separate the debris from billets of a crop material. The airflow device can include a rotor including a plate and one or more blades extending from the plate. At least a portion of the outlet extends vertically below the plate.

### FIELD OF THE INVENTION

The present disclosure relates generally to agricultural harvesters, such as sugarcane harvesters, and, more particularly, to systems and methods for the agricultural harvester.

### BACKGROUND OF THE INVENTION

Agricultural harvesters can include an assembly of processing equipment for processing harvested crop materials. For instance, within a sugarcane harvester, severed sugarcane stalks are conveyed via a feed roller assembly to a chopper assembly that cuts or chops the sugarcane stalks into pieces or billets (e.g., six-inch cane sections). The processed crop material discharged from the chopper assembly is then directed as a stream of billets and debris into a debris removal system, within which the airborne debris (e.g., dust, dirt, leaves, etc.) is separated from the sugar billets. The separated/cleaned billets then fall into an elevator assembly for delivery to an external storage device.

Accordingly, systems and methods for separating the stream of billets and the debris that address one or more issues associated with existing systems/methods would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a debris removal system for an agricultural harvester. The debris removal system can include an extractor housing defining a housing inlet and a housing outlet. The extractor housing further defines an airflow channel for directing debris through the extractor housing from the housing inlet to the housing outlet. An airflow device is configured to generate an airflow from the housing inlet towards the airflow device. The airflow is configured to separate the debris from billets of a crop material. The airflow device includes a rotor including a plate and one or more blades extending from the plate, wherein at least a portion of the housing outlet extends vertically below the plate.

In some aspects, the present subject matter is directed to a method for operating a debris removal system for an agricultural harvester. The agricultural harvester includes a material processing system configured to receive a flow of harvested materials. The method includes generating, with an airflow device having one or more blades, an airflow through a channel defined by an extractor housing from a housing inlet defined by the extractor housing to a housing outlet. The method also includes directing, with the airflow, debris from the housing inlet to the housing outlet defined by the housing, wherein at least a portion of the housing outlet is at least partially positioned vertically below the one or more blades.

In some aspects, the present subject matter is directed to a debris removal system for an agricultural harvester. The debris removal system includes an extractor housing defining a housing inlet and a housing outlet. The extractor housing further defines an airflow channel for directing debris through the extractor housing from the housing inlet to the housing outlet. An airflow device is configured to generate an airflow from the housing inlet towards the airflow device. The airflow is configured to separate the debris from billets of a crop material. The airflow device includes a rotor including a plate and one or more blades extending from the plate, wherein at least a portion of the housing outlet extends vertically below the plate, and a power source operably coupled with the rotor and configured to rotate the rotor about a rotational axis

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural harvester in accordance with aspects of the present subject matter;

FIG. 2 is a schematic view of the debris removal system incorporated within a primary extractor in accordance with aspects of the present subject matter;

FIG. 3 is a perspective view of a rotor of the debris removal system in accordance with aspects of the present subject matter;

FIG. 4A is a perspective view of the debris removal system incorporated within a primary extractor in accordance with aspects of the present subject matter;

FIG. 4B is a cross-sectional view of the debris removal system of FIG. 4A taken along the line IVB-IVB illustrating a computational fluid dynamics (CFD) simulation of airflow through the primary extractor in accordance with aspects of the present subject matter;

FIG. 5A is a perspective view of the debris removal system incorporated within a primary extractor in accordance with aspects of the present subject matter;

FIG. 5B is a cross-sectional view of the debris removal system of FIG. 5A taken along the line VB-VB illustrating a CFD simulation of airflow through the primary extractor in accordance with aspects of the present subject matter;

FIG. 6A is a perspective view of the debris removal system incorporated within a primary extractor in accordance with aspects of the present subject matter;

FIG. 6B is a cross-sectional view of the debris removal system of FIG. 6A taken along the line VIB-VIB illustrating a CFD simulation of airflow through the primary extractor in accordance with aspects of the present subject matter; and

FIG. 7 illustrates a flow diagram of a method for operating a debris removal system for an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a crop within a fluid circuit. For example, “upstream” refers to the direction from which a crop flows, and “downstream” refers to the direction to which the crop moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for a debris removal system for an agricultural harvester. The debris removal system can include a primary extractor that is configured to direct the debris outwardly from the harvester. In various examples, the debris removal system can include an extractor housing defining a housing inlet and a housing outlet. The extractor housing can further define an airflow channel for directing debris through the extractor housing from the housing inlet to the housing outlet

In several examples, an airflow device can be configured to generate an airflow from the housing inlet towards the airflow device. The airflow can be configured to separate the debris from billets of a crop material. In some examples, the airflow device can include a rotor including a plate and one or more blades extending from the plate. In some cases, at least a portion of the housing outlet extends vertically below the plate. The airflow device can also include a power source operably coupled with the rotor and configured to rotate the rotor about a rotational axis.

The airflow device provided herein may allow for sufficient pressure to separate the debris from the billets with the debris then passing through the debris removal system with minimum contact between the debris and the components of the debris removal system. In such instances, the airflow device can create a vortex underneath the entrance to initiate a rotation of the debris before entering into the airflow device, which, in turn, is evacuated more efficiently. In addition, the airflow device provided herein can have less friction against the housing compared to a conventional extractor where the residues have to hit the curved housing, deflect against it, reaccelerate, and are then evacuated. Moreover, the airflow device can have an overall lower fan power requirement than a classic primary extractor fan assembly.

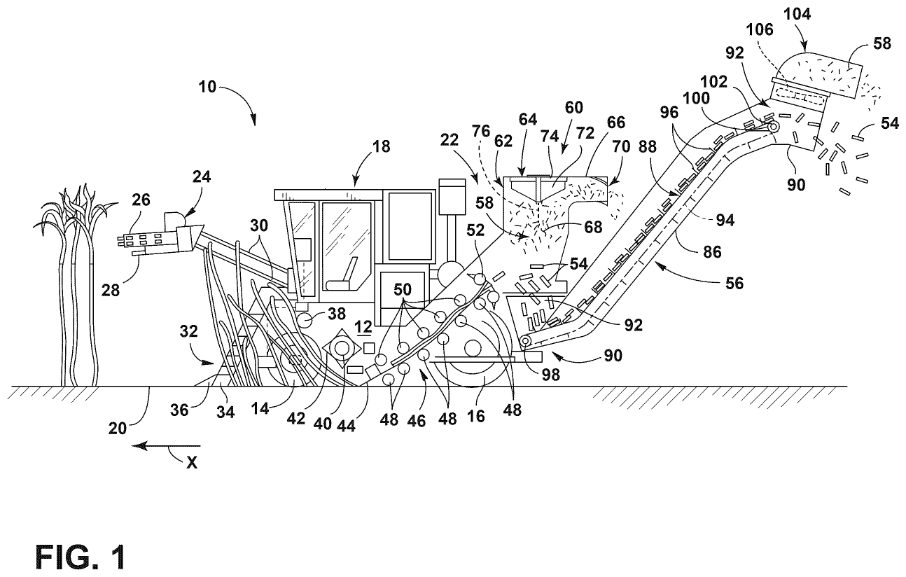

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable agricultural harvester without departing from the teachings provided herein.

As shown in FIG. 1, the harvester 10 includes a frame 12, a pair of front wheels 14, a pair of rear wheels 16, and an operator's cab 18. The harvester 10 may also include a source of power (e.g., an engine mounted on the frame 12) that powers one or both pairs of the wheels 14, 16 via a transmission through an agricultural field 20. Alternatively, the harvester 10 may be a track-driven harvester and, thus, may include tracks driven by the source of power as opposed to the illustrated wheels 14, 16. The source of power may also drive a hydraulic fluid pump configured to generate pressurized hydraulic fluid for powering various hydraulic components of the harvester 10.

The harvester 10 may also include a material processing system 22 incorporating various components, assemblies, and/or sub-assemblies of the harvester 10 for cutting, processing, cleaning, and discharging sugarcane as the cane is harvested from the agricultural field 20. For instance, the material processing system 22 may include a topper assembly 24 positioned at the front end portion of the harvester 10 to intercept sugarcane as the harvester 10 is moved in the forward direction. As shown, the topper assembly 24 may include a gathering disk 26 and/or a cutting disk 28. The gathering disk 26 may be configured to gather the sugarcane stalks so that the cutting disk 28 may be used to cut off the top of each stalk. In some cases, the height of the topper assembly 24 may be adjustable via a pair of arms 30 hydraulically raised and lowered, as desired, by the operator.

The material processing system 22 may further include a crop divider 32 that extends upwardly and rearwardly from the field 20. In general, the crop divider 32 may include two spiral feed rollers 34. Each feed roller 34 may include a ground shoe 36 at its lower end portion to assist the crop divider 32 in gathering the sugarcane stalks for harvesting. Moreover, as shown in FIG. 1, the material processing system 22 may include a knock-down roller 38 positioned near the front wheels 14 and a fin roller 40 positioned behind the knock-down roller 38. As the knock-down roller 38 is rotating, the sugarcane stalks being harvested are knocked down while the crop divider 32 gathers the stalks from agricultural field 20. Further, as shown in FIG. 1, the fin roller 40 may include a plurality of intermittently mounted fins 42 that assist in forcing the sugarcane stalks downward. As the fin roller 40 is rotated during the harvest, the sugarcane stalks that have been knocked down by the knock-down roller 38 are separated and further knocked down by the fin roller 40 as the harvester 10 continues to be moved in the forward direction relative to the field 20.

Referring still to FIG. 1, the material processing system 22 of the harvester 10 may also include a base cutter assembly 44 positioned behind the fin roller 40. In various examples, the base cutter assembly 44 may include blades for severing the sugarcane stalks as the cane is being harvested. The blades, located on the peripheral portion of the base cutter assembly 44, may be rotated by a hydraulic motor powered by the vehicle's hydraulic system. Additionally, in several embodiments, the blades may be angled downward to sever the base of the sugarcane as the cane is knocked down by the fin roller 40.

Moreover, the material processing system 22 may include a feed roller assembly 46 located downstream of the base cutter assembly 44 for moving the severed stalks of sugarcane from base cutter assembly 44 along the processing path of the material processing system 22. As shown in FIG. 1, the feed roller assembly 46 may include a plurality of bottom rollers 48 and a plurality of opposed, top rollers 50. The various bottom and top rollers 48, 50 may be used to pinch the harvested sugarcane during transport. As the sugarcane is transported through the feed roller assembly 46, debris 58 (e.g., rocks, dirt, and/or the like) may be allowed to fall through bottom rollers 48 onto the field 20.

The material processing system 22 may further include a chopper assembly 52 located at the downstream end portion of the feed roller assembly 46 (e.g., adjacent to the rearward-most bottom and top rollers 48, 50). In general, the chopper assembly 52 may be used to cut or chop the severed sugarcane stalks into pieces or “billets” 54, which may be, for example, six (6) inches long. The billets 54 may then be propelled towards an elevator assembly 56 of the material processing system 22 for delivery to an external receiver or storage device.

The pieces of debris 58 (e.g., dust, dirt, leaves, etc.) separated from the sugar billets 54 may be expelled from the harvester 10 through a debris removal system 60 of the material processing system 22 that can include a primary extractor 62, which is located downstream of the chopper assembly 52 and is oriented to direct the debris 58 outwardly from the harvester 10. Additionally, an airflow device 64 is mounted at least partially within a housing 66 of the primary extractor 62. The airflow device 64 may be configured to generate a suction force or vacuum to force the debris 58 through a housing inlet 68 and one or more housing outlets 70 defined by the housing 66. In some instances, an inlet area defined by the housing inlet 68 may be larger than an outlet area defined by the one or more housing outlets 70. In various examples, the airflow device 64 can include a rotor 72, such as an impeller or fan, and a power source 74 configured to rotate the rotor 72 about a rotational axis 76.

The separated or cleaned billets 54, heavier than the debris 58 being expelled through the primary extractor 62, may then be directed to the elevator assembly 56. As shown in FIG. 1, the elevator assembly 56 may include an elevator housing 86 and an elevator 88 extending within the elevator housing 86 between a lower, proximal end portion 90 and an upper, distal end portion 92. In general, the elevator 88 may include a looped chain 94 and a plurality of flights or paddles 96 attached to and evenly spaced on the chain 94. The paddles 96 may be configured to hold the sugar billets 54 on the elevator 88 as the billets 54 are elevated along a top span of the elevator 88 defined between its proximal and distal end portions 90, 92. Additionally, the elevator 88 may include lower and upper sprockets 98, 100 positioned at its proximal and distal end portions 90, 92, respectively. As shown in FIG. 1, an elevator motor 102 may be coupled to one of the sprockets (e.g., the upper sprocket 100) for driving the chain 94, thereby allowing the chain 94 and the paddles 96 to travel in a loop between the proximal and distal end portions 90, 92 of the elevator 88.

Moreover, in some embodiments, the pieces of debris 58 (e.g., dust, dirt, leaves, etc.) separated from the elevated sugar billets 54 may be expelled from the harvester 10 through a secondary extractor 104 of the debris removal system 60 coupled to the rear end portion of the elevator housing 86. For example, the debris 58 is expelled by the secondary extractor 104 remaining after the billets 54 are cleaned and debris 58 is expelled by the primary extractor 62. As shown in FIG. 1, the secondary extractor 104 may be located adjacent to the distal end portion 92 of the elevator 88 and may be oriented to direct the debris 58 outwardly from the harvester 10. In various examples, the secondary extractor 104 may include any of the components described with reference to the primary extractor 62. Additionally or alternatively, an extractor fan 106 may be mounted at the base of the secondary extractor 104 for generating a suction force or vacuum sufficient to force the debris 58 through the secondary extractor 104. The separated, cleaned billets 54, heavier than the debris 58 expelled through the extractor 104, may then fall from the distal end portion 92 of the elevator 88. In some examples, the billets 54 may be directed into an elevator discharge opening of the elevator assembly 56 into an external storage device, such as a sugar billet cart.

During operation, the harvester 10 is traversed across the agricultural field 20 for harvesting sugarcane. After the height of the topper assembly 24 is adjusted via the arms 30, the gathering disk 26 on the topper assembly 24 may function to gather the sugarcane stalks as the harvester 10 proceeds across the field 20, while the cutter disk 28 severs the leafy tops of the sugarcane stalks for disposal along either side of harvester 10. As the stalks enter the crop divider 32, the ground shoes 36 may set the operating width to determine the quantity of sugarcane entering the throat of the harvester 10. The spiral feed rollers 34 then gather the stalks into the throat to allow the knock-down roller 38 to bend the stalks downwardly in conjunction with the action of the fin roller 40. Once the stalks are angled downward as shown in FIG. 1, the base cutter assembly 44 may then sever the base of the stalks from field 20. The severed stalks are then, by the movement of the harvester 10, directed to the feed roller assembly 46.

The severed sugarcane stalks are conveyed rearwardly by the bottom and top rollers 48, 50, which compress the stalks, make them more uniform, and shake loose debris 58 to pass through the bottom rollers 48 to the field 20. At the downstream end portion of the feed roller assembly 46, the chopper assembly 52 cuts or chops the compressed sugarcane stalks into pieces or billets 54 (e.g., six-inch cane sections). The processed crop material discharged from the chopper assembly 52 is then directed as a stream of billets 54 and debris 58 into the primary extractor 62. The airborne debris 58 (e.g., dust, dirt, leaves, etc.) separated from the billets 54 is then extracted through the primary extractor 62 using suction created by the airflow device 64. The separated/cleaned billets 54 are then directed into an elevator hopper into the elevator assembly 56 and travel upwardly via the elevator 88 from its proximal end portion 90 to its distal end portion 92. During normal operation, once the billets 54 reach the distal end portion 92 of the elevator 88, the billets 54 fall through the elevator discharge opening to an external storage device. If provided, the secondary extractor 104 (with the aid of the extractor fan 106) blows out trash/debris 58 from harvester 10, similar to the primary extractor 62.

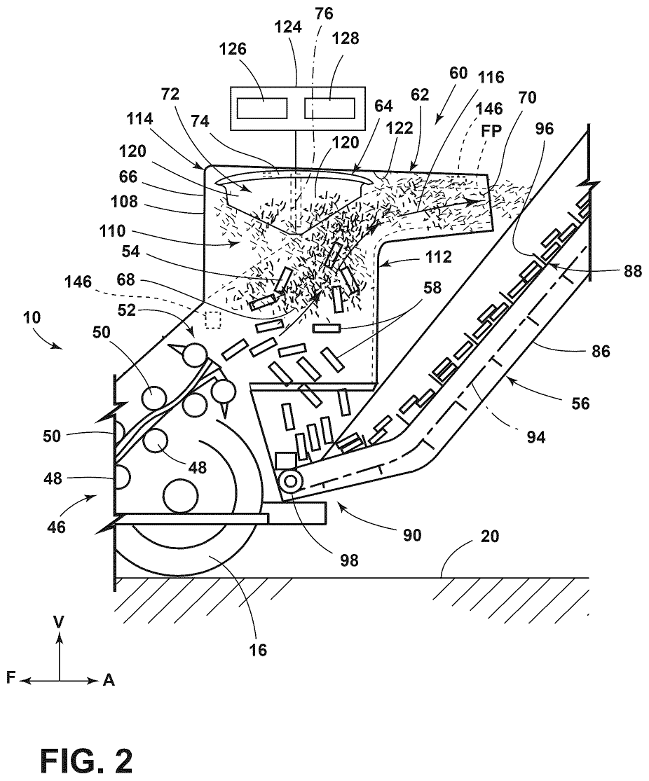

Referring now to FIG. 2, in the illustrated example, the debris removal system 60 is installed relative to the primary extractor 62 of the harvester 10 in accordance with aspects of the present subject matter. However, it will be appreciated that, in general, the debris removal system 60 described herein may be utilized within the primary extractor 62 and/or the secondary extractor 104 of a harvester 10. Thus, although the examples of the disclosed debris removal system 60 will generally be described herein with reference to the primary extractor 62, the debris removal system 60 may also be installed in operative association with the secondary extractor 104 without departing from the scope of the present disclosure.

In general, the debris removal system 60 may include an extractor, such as the primary extractor 62 shown in FIG. 2. As shown, the extractor housing 66 may include an exterior housing wall 108 extending around the outer perimeter of the housing 66 such that the housing 66 defines an airflow channel 110 between the extractor inlet 68 and the outlet 70 for directing the debris 58 through the housing 66 for subsequent discharge from the extractor 62 via the outlet 70. In several examples, the wall 108 of the housing 66 may correspond to a continuous wall member extending between the extractor inlet 68 and outlet 70, or the wall 108 may correspond to two or more wall sections coupled together to form the extractor housing 66. For instance, as shown in FIG. 2, the extractor housing 66 may include both a lower wall or first portion 112 extending upwardly from the extractor inlet 68 and an upper wall or second portion 114 extending outwardly from the lower wall or first portion 112 to the extractor outlet 70. As such, the debris 58 directed through the extractor housing 66 may flow upwardly from the inlet 68 through the vertical section of the airflow channel 110 defined by the lower wall or first portion 112 of the housing 66 and then flow through the section of the airflow channel 110 defined by the second portion 114 of the housing 66 before being discharged from the extractor 62 at the extractor outlet 70.

Additionally, the debris removal system 60 may include the one or more airflow devices 64 provided in operative association with the extractor 62 for generating a negative pressure or vacuum within the extractor housing 66. For example, the airflow device 64 may be configured to generate an upwardly-directed airflow path within the extractor housing 66 (e.g., as indicated by arrow 116 in FIG. 2), such as by creating a suction, a vortex, and/or whirlwind within the housing 66. In various instances, the suction force at the extractor inlet 68 draws the debris 58 upwardly away from the stream of billets 54 expelled from the chopper assembly 52 and into the airflow channel 110 defined by the extractor housing 66 for subsequent delivery to the extractor outlet 70. The cleaned billets 54 may then fall onto the elevator assembly 56 for transport to a suitable receiver.

It should be appreciated that the airflow device 64 may generally correspond to any suitable device or mechanism configured to generate an airflow through the extractor housing 66. For instance, in several embodiments, the airflow device 64 may include the rotor 72 and the power source 74. The rotor 72 may include one or more blades 120 and be configured as a high-head closed channel impeller, a vortex impeller, a centrifugal screw impeller, a propeller, a shredder impeller, a closed channel impeller, a mixed flow impeller, a semi-open impeller, and/or a hardened slurry impeller for generating a negative pressure or vacuum within the housing 66 through actuation of a power source 74 operably coupled with the rotor 72. Alternatively, the airflow device 64 may correspond to any other suitable device or mechanism, such as one or more fan assemblies (e.g., a centrifugal fan assembly).

In various examples, the rotor 72 may be driven using a power source 74, such as an electric or hydraulic motor. In some instances, the power source 74 can be positioned between an interior surface 122 of the housing 66 and the rotor 72. In such instances, at least a portion of the power source 74 and/or the rotor 72 may be recessed relative to the channel 110. Additionally or alternatively, the power source 74 can be positioned at least partially above the housing 66 in a vertical direction V. In operation, the power source 74 may cause the rotor 72 to rotate about a rotational axis 76. In some cases, the rotational axis 76 may be generally aligned with a central axis or region of the housing inlet 68 and/or offset from the housing outlet 70 in the fore-aft direction F-A.

In some examples, such as the one illustrated in FIG. 2, the airflow device 64 may be configured to be positioned proximate to an upper section of the housing 66. For instance, in the illustrated embodiment, at least a portion of the outlet 70 can extend vertically below a portion of the airflow device 64, and/or the airflow device 64 may be generally at least partially positioned away from the flowpath of the debris 58. In such instances, the airflow device 64 can create a circular churning motion around an axis that creates suction for the debris 58 to flow into the channel 110 and is discharged through the outlet 70. Since the airflow device 64 can be positioned at least partially above the flowpath FP, at least some of the debris 58 may be exhausted through the outlet 70 while maintaining a position that is below at least a portion of the airflow device 64, and possibly, without direct contact with the airflow device 64. However, in other embodiments, the airflow device 64 may be positioned at any other suitable location around the outer perimeter of the extractor 62, such as at or adjacent to the hood-shaped upper portion of the extractor housing 66. Unlike axial flow extractor fans that occupy a significant portion of the airflow channel 110 defined by the extractor housing 66, the disclosed airflow device 64 can allow a substantial portion of the airflow channel 110 (e.g., a central flow region of the channel 110) to be an unobstructed flow path FP for air/debris through the extractor 62.

In various examples, the debris removal system 60 can include a computing system 124 operably coupled with the primary extractor 62. In various examples, the operational parameters of the airflow device 64 may be based on various conditions. For instance, in some cases, the operational conditions of the airflow device 64 may be based on the amount of debris 58 and/or the detected content of the debris 58. However, it will be appreciated that the operational conditions of the airflow device 64 may be based on any other condition without departing from the teachings provided herein.

In general, the computing system 124 may be configured as any suitable processor-based device, such as a computing device or any suitable combination of computing devices. Thus, in several embodiments, the computing system 124 may include one or more processors 126 and associated memory 128 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 128 of the computing system 124 may generally comprise memory elements including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 128 may generally be configured to store information accessible to the processor 126, including data that can be retrieved, manipulated, created, and/or stored by the processor 126 and instructions that can be executed by the processor 126, when implemented by the processor 126, configure the computing system 124 to perform various computer-implemented functions, such as one or more aspects of the image processing algorithms and/or related methods described herein. In addition, the computing system 124 may also include various other suitable components, such as a communications circuit or module, one or more input/output channels, a data/control bus, and/or the like.

In various embodiments, the computing system 124 may correspond to an existing controller of the harvester 10, or the computing system 124 may correspond to a separate processing device. For instance, in some embodiments, the computing system 124 may form all or part of a separate plug-in module or computing device that is installed relative to the harvester 10 to allow for the debris removal system 60 and related methods to be implemented without requiring additional software to be uploaded onto existing control devices of the harvester 10. Further, the various functions of the computing system 124 may be performed by a single processor-based device or may be distributed across any number of processor-based devices, in which instance such devices may be considered to form part of the computing system 124. For instance, the functions of the computing system 124 may be distributed across multiple application-specific controllers.

In some instances, a sensor 146 operably may be coupled with the computing system 124. The sensor 146 can be configured to detect one or more conditions associated with the debris 58. For example, the one or more conditions can include an amount of debris 58, a detected content of the debris 58, a debris or crop moisture level, and/or any other detectable condition. In various examples, the computing system 124 may be configured to alter a rotational speed of the rotor 72 based at least partially on the one or more conditions. In various examples, the sensor 146 may be configured as one or more of an imaging device, a positioning device (e.g., an accelerometer, global positioning system, etc.), a proximity sensor, an electromagnetic radiation sensor (e.g., an infrared sensor, a passive infrared sensor, etc.), an ultrasonic sensor, color sensor, a humidity sensor, a magnetic sensor (e.g., a hall effect sensor), a microphone (sound sensor), a pressure sensor, and/or any other type of sensor.

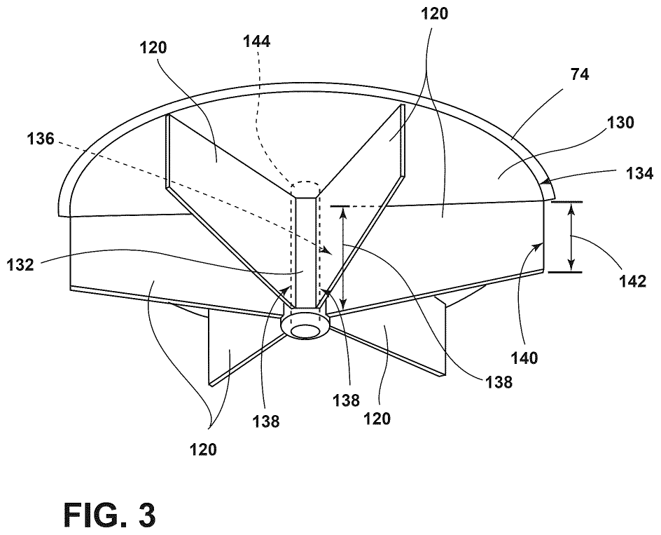

Referring now to FIG. 3, in various examples, the airflow device 64 can include the rotor 72 and the power source 74. As illustrated, the rotor 72 can include a plate 130 and a hub 132. In some instances, the one or more blades 120 are equally spaced radial blades that extend from the hub 132 towards a peripheral portion 134 of the plate 130. In various examples, the plate 130 may be generally planar or have portions thereof that are of convex shape. As illustrated, each of the one or more blades 120 can include a proximal portion 136 operably coupled with the hub 132. The respective proximal portions 136 can define a proximal height 138. Each of the one or more blades 120 can also include a distal portion 140 defining a distal height 142. In some instances, the distal height 142 can be less than the proximal height 138. This design provides more material at stress areas on the portion of the blades 120 closest to the hub 132 and facilitates the use of a single hub to be used for rotors 72 of varying radii. However, it will be appreciated that the distal portions 140 of each blade may be greater in higher than the proximal portions 136 or equal in height to the proximal portions 136 without departing from the teachings provided herein.

With further reference to FIG. 3, the airflow device 64 may include a power source 74 (e.g., an electric or hydraulic motor) coupled to the rotor 72. In various examples, the power source 74 and the rotor 72 may be coupled with a common shaft 144 to rotate the rotor 72 such that a high-velocity, high-pressure stream of airflow is transferred from the inlet 68 of the housing 66 to the outlet 70. It will be appreciated that while the rotor 72 illustrated in FIG. 3 includes a radial blade, the rotor 72 may include any other type of blade design without departing from the scope of the present disclosure.

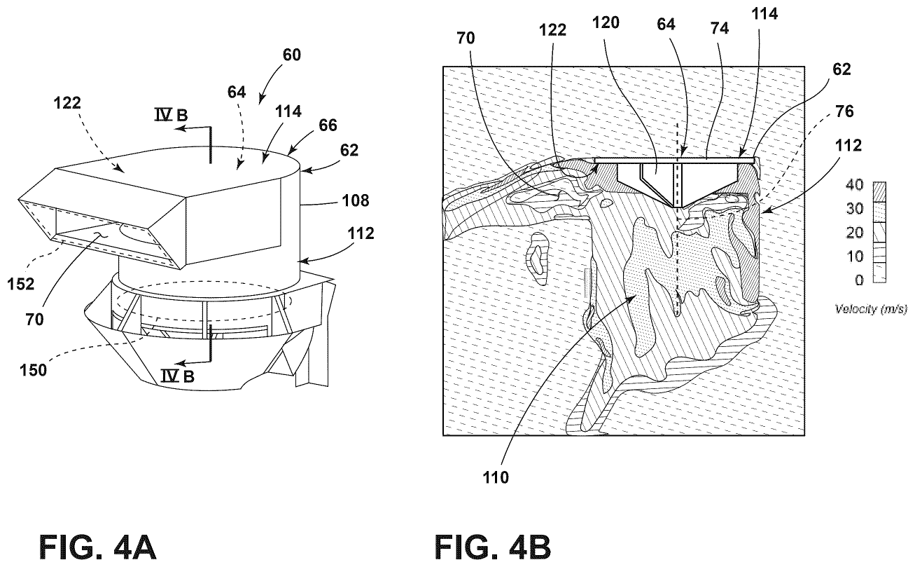

Referring to FIGS. 4A-6B, various perspective views and simulated airflow velocity maps of some examples of a debris removal system 60 installed relative to the primary extractor 62 of the harvester 10 are illustrated in accordance with aspects of the present subject matter. It will be appreciated that, in general, the system 60 described herein may be utilized to replace one or more components of the primary extractor 62 and/or one or more components of the secondary extractor 104 of a harvester 10. Thus, although the illustrated examples of the disclosed system 60 will generally be described herein with reference to the primary extractor 62, the system 60 may also be installed in an operative associated with the secondary extractor 104.

As provided herein, the extractor housing 66 may include both a lower wall or first portion 112 extending upwardly from the extractor inlet 68 and an upper wall or second portion 114 extending outwardly from the lower wall or first portion 112 to the extractor outlet 70. As such, the debris 58 directed through the extractor housing 66 may flow upwardly from the inlet 68 through the vertical section of the airflow channel 110 defined by the lower wall or first portion 112 of the housing 66 and then flow through the section of the airflow channel 110 defined by the second portion 114 of the housing 66 before being discharged from the extractor 62 at the extractor outlet 70.

With further reference to FIGS. 4A-6B, in some examples, the first portion of the housing 66 may define an inlet area 150 and the second portion of the housing 66 may define an outlet area 152. As illustrated, the inlet area 150 may be greater than the outlet area 152. However, in various examples, the inlet area 150 may be equal to or smaller than the outlet area 152.

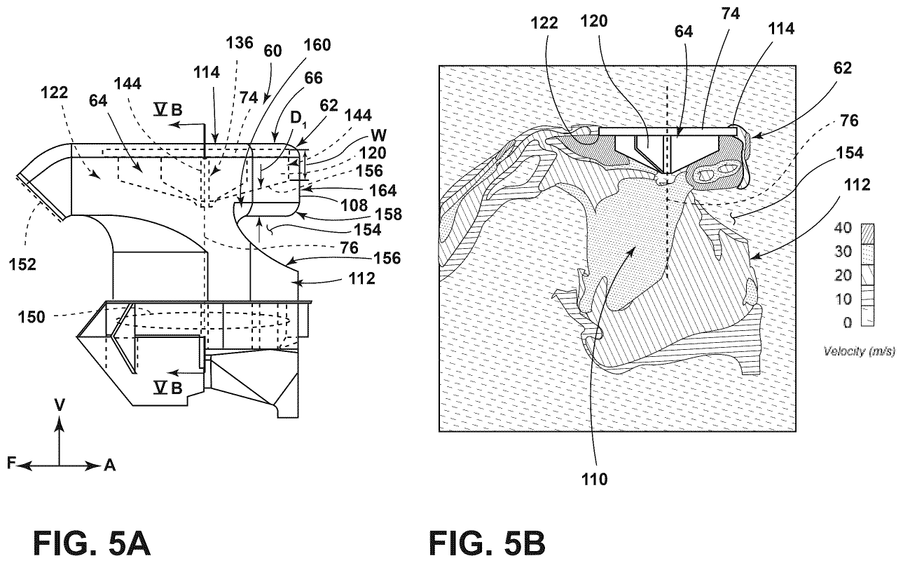

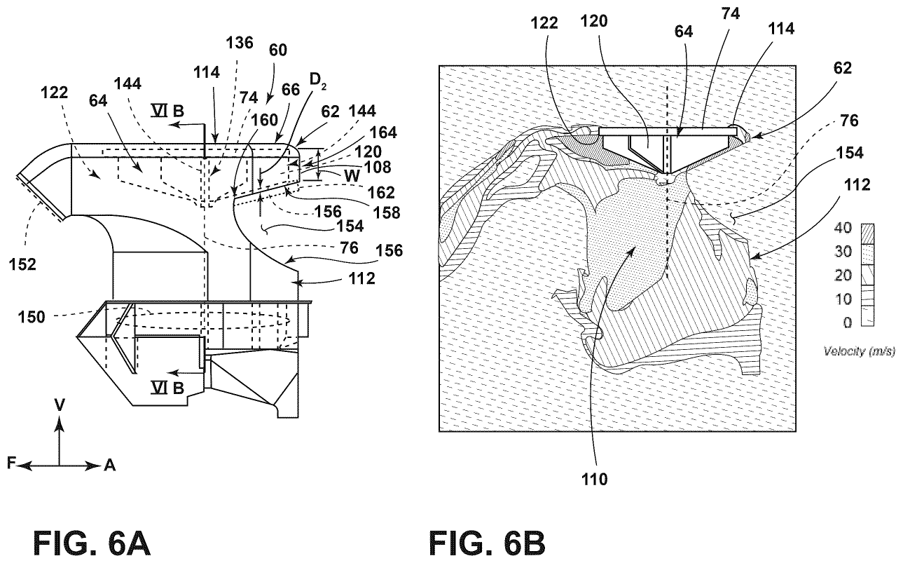

In some examples, such as those illustrated in FIGS. 5A-6B, the first portion of the housing 66 may define a notch 154, and/or any other formation that is configured to alter an airflow path and/or velocity within the channel 110 of the housing 66. In some cases, the first portion of the housing 66 can define the notch 154. Moreover, the notch 154 can extend towards a rotational axis 76 of the rotor 72. In such cases, a first distance between the notch 154 and the rotational axis 76 can be less than a second distance from a distal portion 140 of the one more blades 120 and the rotational axis 76. In various instances, the distance between the notch 154 and the airflow device 64 can be designed to ensure the cleanliness of the housing 66.

As illustrated in FIGS. 5A-6B, the notch 154 may be defined by a first section 156 and a second section 158 that intersect at an inner region 160 (relative to the rotation axis 76). A distance D₁ (FIG. 5A), D₂ (FIG. 6A) may be defined between the one or more blades 120 and an interior surface of the second section. The distance may be varied based on the design configuration of the extractor 62. As shown in FIGS. 5A and 5B, the distance D₁ may be at least 0.2 times the width w (and/or any other factor) of the one or more blades 120 at the distal portion 140 of the one or more blades 120. Additionally or alternatively, the second section 158 that defines the notch 154 may be orientated in a non-parallel direction to that of the one or more blades 120. As shown in FIGS. 6A and 6B, the distance D₂ may equal to or less than 0.2 times the width w (and/or any other factor) of the one or more blades 120 at the distal portion 140 of the one or more blades 120. Additionally or alternatively, the second section 158 that defines the notch 154 may be orientated in a generally parallel direction to that of the one or more fan blades 120.

In some instances, the primary extractor 62 may further include and/or define a bypass channel 162 to allow airflow within a cavity 164 of the primary extractor 62 that is on an opposing side of the rotational axis 76 from the outlet area 152. In some instances, due to a small gap between the notch 154 and the one or more blades 120, the bypass channel 162 may allow additional airflow into the cavity 164 to alter and/or adjust an airflow pattern within the primary extractor 62.

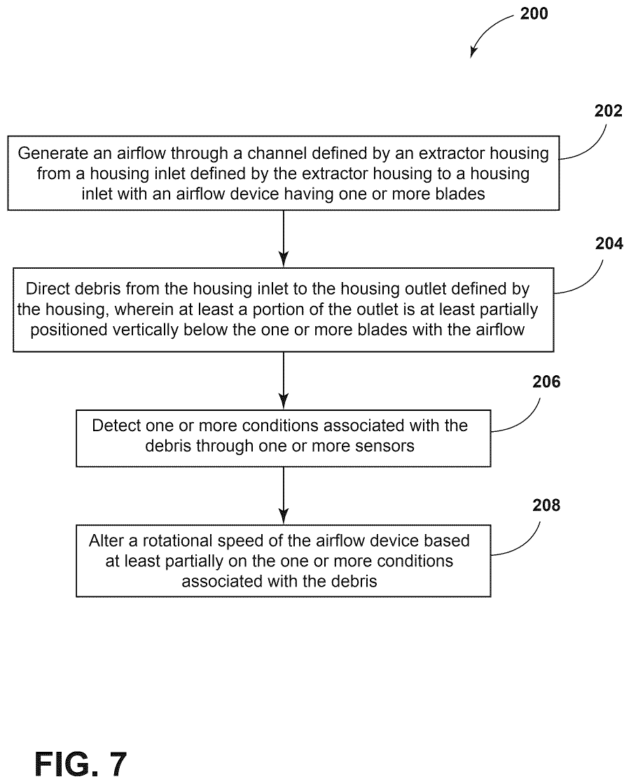

Referring now to FIG. 7, a flow diagram of a method 200 for operating a debris removal system for an agricultural harvester is illustrated in accordance with aspects of the present subject matter. In general, the method 200 will be described herein with reference to the agricultural harvester 10 and related components described with reference to FIGS. 1-6B. As such, the agricultural harvester can include a material processing system configured to receive a flow of harvested materials. However, it will be appreciated that the disclosed method 200 may be implemented with harvesters having any other suitable configurations and/or within systems having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 7, at (202), the method 200 can include generating an airflow through a channel defined by an extractor housing from a housing inlet defined by the extractor housing to a housing inlet with an airflow device having one or more blades. In some cases, the airflow can be a suction through a flowpath from the housing inlet towards the housing outlet. In addition, the flowpath is at least partially offset from the one or more blades. Moreover, in various examples, the airflow device can be configured as a radial fan, a centrifugal fan, and/or any other practicable device.

At (204), the method 200 can include directing debris from the housing inlet to the housing outlet defined by the housing, wherein at least a portion of the outlet is at least partially positioned vertically below the one or more blades with the airflow.

At (206), the method 200 can include detecting one or more conditions associated with the debris through one or more sensors. As provided herein, the sensor may be configured as one or more of an imaging device, a positioning device (e.g., an accelerometer, global positioning system, etc.), a proximity sensor, an electromagnetic radiation sensor (e.g., an infrared sensor, a passive infrared sensor, etc.), an ultrasonic sensor, a color sensor, a humidity sensor, a magnetic sensor (e.g., a hall effect sensor), a microphone (sound sensor), a pressure sensor, and/or any other type of sensor.

At (208), the method 200 can include altering a rotational speed of the airflow device based at least partially on the one or more conditions associated with the debris. In various examples, the one or more conditions can include an amount of debris, a detected content of the debris, and/or a debris or crop moisture level. However, it will be appreciated that the use of the airflow device may be based on any other condition without departing from the teachings provided herein. In various examples, the method 200 may implement machine learning methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the operation of the airflow device and/or any other component of the debris removal assembly. In some instances, the machine learning engine may allow for changes to the operation of the airflow device and/or any other component of the debris removal assembly to be performed without human intervention.

It is to be understood that the steps of the method 200 are performed by the computing system upon loading and executing software code or instructions that are tangibly stored on a tangible computer-readable medium, such as on a magnetic medium, e.g., a computer hard drive, an optical medium, e.g., an optical disk, solid-state memory, e.g., flash memory, or other storage media known in the art. Thus, any of the functionality performed by the computing system described herein, such as the method 200, is implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing system, the computing system may perform any of the functionality of the computing system described herein, including any steps of the method 200 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A debris removal system for an agricultural harvester, the debris removal system comprising:
an extractor housing defining a housing inlet and a housing outlet, the extractor housing further defining an airflow channel for directing debris through the extractor housing from the housing inlet to the housing outlet; and
an airflow device configured to generate an airflow from the housing inlet towards the airflow device, wherein the airflow configured to separate the debris from billets of a crop material, the airflow device comprising:
a rotor including a plate and one or more blades extending from the plate, wherein at least a portion of the housing outlet extends vertically below the plate.

2. The system of claim 1, further comprising:
a power source may be operably coupled with the rotor and configured to rotate the rotor relative to the extractor housing about a rotational axis.

3. The system of claim 2, wherein the power source is positioned between the plate and an interior surface of the housing.

4. The system of claim 1, wherein an inlet area defined by the housing inlet is larger than an outlet area defined by the housing outlet.

5. The system of claim 1, wherein the rotor is configured as a radial fan including the one or more blades extending outwardly from a hub and the plate.

6. The system of claim 5, wherein each of the one or more blades has a proximal portion operably coupled with the hub and defining a proximal height and a distal portion defining a distal height, the distal height less than the proximal height.

7. The system of claim 1, wherein the extractor housing defines a first portion at least partially below the housing outlet in a vertical direction and a second portion above the first portion, and wherein the first portion defines a notch.

8. The system of claim 7, wherein the notch extends towards a rotational axis of the rotor, a first distance between the notch and the rotational axis being less than a second distance from a distal portion of the one more blades and the rotational axis.

9. The system of claim 7, wherein a rotational speed of the rotor is at least partially based on one or more detected conditions.

10. A method for operating a debris removal system for an agricultural harvester, the agricultural harvester including a material processing system configured to receive a flow of harvested materials, the method comprising:
generating, with an airflow device having one or more blades, an airflow through a channel defined by an extractor housing from a housing inlet defined by the extractor housing to a housing outlet; and
directing, with the airflow, debris from the housing inlet to the housing outlet defined by the housing, wherein at least a portion of the housing outlet is at least partially positioned vertically below the one or more blades.

11. The method of claim 10, further comprising:
detecting, through one or more sensors, one or more conditions associated with the debris.

12. The method of claim 11, further comprising:
altering a rotational speed of the airflow device based at least partially on the one or more conditions associated with the debris.

13. The method of claim 10, wherein the airflow device is configured as a radial fan.

14. The method of claim 10, wherein the airflow device is configured as a centrifugal fan.

15. The method of claim 10, wherein the airflow is a suction through a flowpath from the housing inlet towards the housing outlet, and wherein the flowpath is at least partially offset from the one or more blades.

16. A debris removal system for an agricultural harvester, the debris removal system comprising:
an extractor housing defining a housing inlet and a housing outlet, the extractor housing further defining an airflow channel for directing debris through the extractor housing from the housing inlet to the housing outlet; and
an airflow device configured to generate an airflow from the housing inlet towards the airflow device, wherein the airflow configured to separate the debris from billets of a crop material, the airflow device comprising:
a rotor including a plate and one or more blades extending from the plate, wherein at least a portion of the housing outlet extends vertically below the plate; and
a power source operably coupled with the rotor and configured to rotate the rotor about a rotational axis.

17. The system of claim 16, wherein the power source is positioned between an interior surface of the extractor housing and the rotor.

18. The system of claim 16, wherein the power source is positioned at least partially above the extractor housing in a vertical direction.

19. The system of claim 16, further comprising:
a sensor operably coupled with a computing system and configured to detect one or more conditions associated with the debris.

20. The system of claim 19, wherein the computing system is configured to alter a rotational speed of the rotor based at least partially on the one or more conditions.
